(19) United States
(12) Patent Application Publication
(10) Pub. No.: US 2004/0044600 A1
(43) Pub. Date: Mar. 4, 2004

(54) Cost management for a distributed computing environment

(76) Inventors: Hao-Hua Chu, Mountain View, CA (US); Masaji Katagiri, Los Altos, CA (US)

Correspondence Address: BRINKS HOFER GILSON & LIONE, ONE INDIANA SQUARE, SUITE 1600, INDIANAPOLIS, IN, 46204-2033, US

(21) Appl. No.: 10/228,928

(22) Filed: Aug. 27, 2002

(51) Int. Cl. G06F 17/60

(52) U.S. Cl. 705/34

(57) ABSTRACT

A cost management system for a mobile computing environment is disclosed. The cost management system includes software routines executed by a client terminal and a server in communication via a data infrastructure. The client terminal may send a data service cost request to the server to discover a cost for accessing a data service provided by the server computer. The server may respond to the request with a data service cost response indicating this cost. The cost management system may then inform a user of the cost, and allow the user to decide whether to access the data service.

### FIELD OF THE INVENTION

The present invention relates generally to a mobile computing environment, and more particularly to a method and system for providing a cost management system for a mobile computing environment.

### BACKGROUND OF THE INVENTION

One common distributed computing environment utilizes a circuit-switched data infrastructure. In a circuit-switched data infrastructure, a computing device may establish a communications circuit with the data infrastructure of a communications service provider (CSP). The circuit may be a continuous channel having a fixed bandwidth. The data infrastructure may be a network. Once the circuit is established, a user may use the computing device to either access or provide a data service via the data infrastructure.

A user may use the computing device to access a data service, such as a web page. The data service may be provided by the CSP or by a third party, and may be provided for a fee, or provided free of charge. When the user has finished accessing the data service, the computing device may be disconnected from the CSP. While the communication device is connected to the CSP, there is a “continuous” circuit established between the computing device and the data infrastructure.

Another common distributed computing environment utilizes a packet-switched data infrastructure. In a packet-switched data infrastructure, digital packets are communicated between the data infrastructure and a computing device only when there is data to transfer. In a packet-switched data infrastructure, the computing device is continuously “connected” to the data infrastructure. The data infrastructure may be a network, however no “communications circuit” is opened until there is data to transfer. Therefore, little or no bandwidth is consumed when no data is being communicated. The CSP may charge for services on a per packet basis.

For example, a user may use a computing device to access a data service, such as reading e-mail, via a packet-switched data infrastructure. Before the user requests the e-mail download, there may be no data packets communicated between the computing device and the CSP, except the occasional system-level control packets. When the user requests the e-mail download, packets containing the request may be transmitted from the computing device to the CSP. If necessary, the CSP may forward the packets to a third party e-mail service provider. If the CSP provides the e-mail service, the CSP may directly respond to the request by transmitting packets containing e-mail messages to the computing device. The computing device may interpret the packets and display the e-mail messages for the user.

One advantage of using a packet-switched data infrastructure is that users may be billed only for data that is communicated on a per-packet basis. For example, a user who accesses 50 data-rich web pages a day and e-mails 20 documents a day may be charged more than a user who accesses two web pages a day and sends no e-mail. In this manner, users may be billed proportionally to the infrastructure resources they consume.

On the other hand, one disadvantage of a per-packet billing structure is that users do not have the ability to calculate service costs. This is especially true for data services such as web browsing and e-mail access where a user may have no foreknowledge of the content. For example, when a user selects a web link that points to a document or a continuous streaming media, the user may not know the number of data packets required to transfer the document or a continuous streaming media. It would be desirable to provide a cost management system for a per-packet billing structure that allows a user to control costs associated with accessing data services via a packet-switched data infrastructure. It would also be desirable to provide a cost management system for peripheral devices that can be connected with computing devices such as printers, cameras, displays and so forth.

### SUMMARY OF THE INVENTION

A cost management system is provided for managing data service costs incurred by a terminal configured to access a data service via an access network. The cost management system includes a cost management application that is used by the terminal. The cost management application is executed by the terminal and operable to send a data service cost request via the access network and to receive a data service cost response via the access network. The data service cost response indicates a data service cost.

The cost management system may further interact with a client application. The client application may be executed by the terminal and operable to access the data service. The cost management system provides the data service cost to the client application, and the client application may present the data service cost to a user. The client application may be a web browser. If the client application is a web browser, it may present the data service cost to the user in a frame, as rollover text, or in a pop-up window.

The client application may be operable to send a data service request to access the data service and the cost management application may be operable to append the data service cost request to the data service request. The data service cost request may be contained in a message formatted in accordance with a standard generalized transfer protocol, such as hyper-text transfer protocol (“HTTP”) or wireless application protocol (“WAP”).

The data service cost may represent an estimated cost or an actual cost incurred by accessing the data service. The cost management application may determine, during access to the data service, an actual cost incurred by accessing the data service, calculate the difference between the actual fee and the estimated fee, and alert the user if the difference is greater than a threshold error value. The terminal may access the data service by sending and receiving data packets via the access network and the actual fee incurred by accessing the data service can be based on the number of packets sent and received by the terminal.

The cost management application may store a user budget preference and determine whether accessing a data service will violate the user budget preference. The user budget preference may include a plurality of user budget preferences, such as a maximum cost incurred by accessing a data service. The cost management application may determine an actual cost incurred by accessing a data service and add the actual cost to a cumulative cost. The cumulative cost may represent the sum of previous actual costs incurred by accessing data services over a period of time. The user budget preferences may be a maximum cumulative fee over the period of time. The period of time may be a day, a week, or a month.

The data service cost response may represent a plurality of data service costs. Each data service cost may correspond to a quality of service level. The cost management application may present the plurality of data service costs and corresponding quality of service levels to the user. The client application may access the data service at a quality of service level chosen by the user.

The data service may be a distributed application having a client component and a server component. Accessing the data service may include the terminal receiving data packets containing the client component via the access network, executing the client component, and communicating data packets via the access network between the client component and the server component. The cost incurred by accessing the data service may be a function of the number of packets communicated by the terminal via the access network.

A cost management system is provided for managing data service costs incurred by a terminal configured to access a plurality of data services and a cost-aware portal server. The terminal and the cost-aware portal server are connected to each other through an access network. The cost management system may include a cost management application. The cost management application may be executed by the terminal and is operable to send a data service recommendation request and receive a data service recommendation response from the cost-aware portal service.

The cost management system may further include a cost-aware portal service. The cost-aware portal service is executed by the cost-aware portal server and is operable to respond to the data service recommendation request by generating the data service recommendation response. Each data service may offer different Quality of Services at different prices. In addition, there may be multiple service providers that offer similar data service. The cost-aware portal service collects pricing information on different service providers and their Quality of Services, and then recommends to the user according to his/her cost preference.

The cost management application may be further operable to determine the cost incurred by accessing a data service, store the cost, and associate the cost with the data service. The cost incurred by accessing the data service may include a per access cost for accessing the data service and a monthly fee for accessing the data service.

The cost-aware portal service may be further operable to receive the data service cost associated with the data service from the cost management application via the access network. The data service cost may be stored in a data service profile and kept in a database managed by the cost-aware portal service. The data service profile database may further include a list of comparable data services of the plurality of data services.

Further objects and advantages of the present invention will be apparent from the following description, reference being made to the accompanying drawings wherein preferred embodiments of the invention are clearly illustrated.

### BRIEF DESCRIPTION OF THE DRAWINGS

FIG. 1 is a system-level block diagram a distributed computing system.

FIG. 2 is an illustrative data service selection page generated on a display of a terminal.

FIG. 3 is an illustrative select type page generated on a display of a terminal.

FIG. 4 is an illustrative recommended data services page generated on a display of a terminal.

FIG. 5 is an illustrative quality of service page generated on a display of a terminal.

FIG. 6 is an illustrative data service page generated on a display of a terminal.

FIG. 7 is an illustrative offload component page generated on a display of a terminal.

FIG. 8 is an illustrative select type page generated on a display of a terminal.

FIG. 9 is an illustrative select type page generated on a display of a terminal.

FIG. 10 is an illustrative data access network page generated on a display of a terminal.

FIG. 11 is an illustrative budget preference page generated on a display of a terminal.

FIG. 12 is an illustrative flowchart for a data service selection routine.

FIG. 13 is an illustrative flowchart for a select type routine.

FIG. 14 is an illustrative flowchart for a select quality of service routine.

FIG. 15 is an illustrative flowchart for an access selected data service routine.

FIG. 16 is an illustrative flowchart for an access selected data service routine.

FIG. 17 is an illustrative flowchart a select CSP routine.

FIG. 18 is an illustrative flowchart set budget preferences routine

FIG. 19 is a flow chart representing a software routine executed by a server in a distributed computing system.

FIG. 20 is a flow chart representing a software routine executed by a cost-aware database server in the distributed computing system.

### DETAILED DESCRIPTION OF THE PRESENTLY PREFERRED EMBODIMENTS

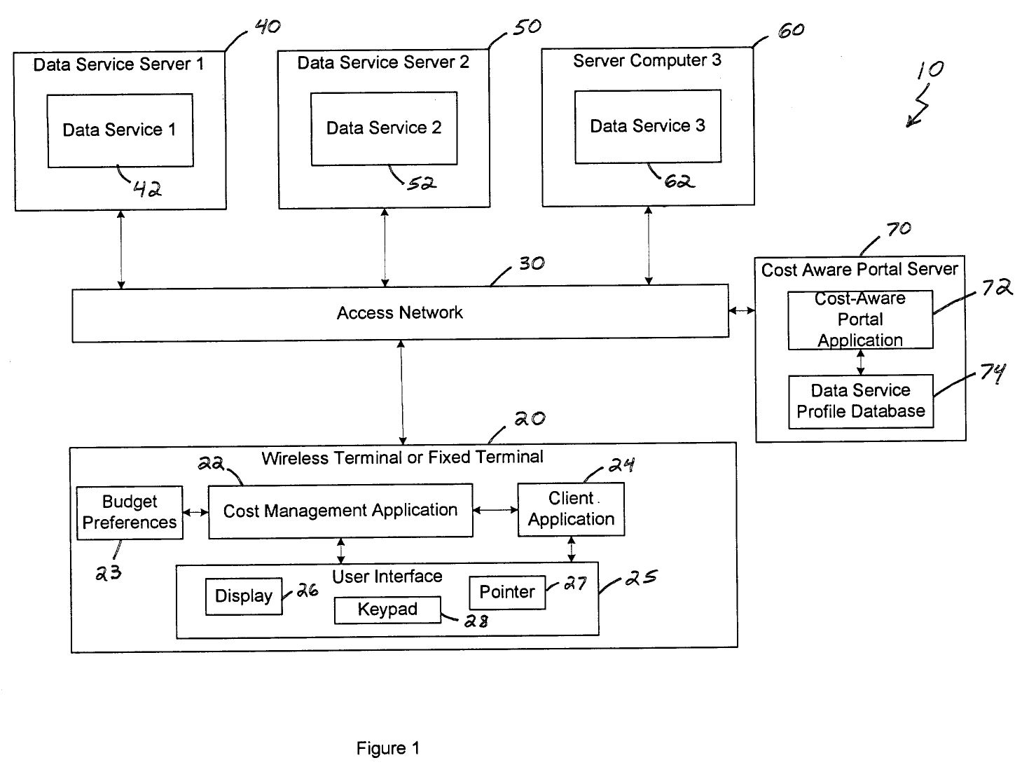

FIG. 1 is a system level block diagram of a distributed computing system 10. The distributed computing system 10 may be any computing environment where one or more user terminals access data services from one or more servers. The configuration of the distributed computing system 10 shown in FIG. 1 is merely illustrative. In the preferred embodiment of the present invention, the distributed computing system 10 is a wireless communication system that includes a plurality of wireless communication devices that are connected to a wireless access network, which is preferentially an all-IP wireless access network.

The distributed computing system 10 preferentially includes: a wireless communication device or terminal, access network 30, a first data service server 40, a second data service server 50, a third data service server 60, and cost-aware portal server 70. The wireless communication device 20 may access data services provided by the first, second, and third data service servers 40, 50, 60 via the access network 30. As set forth above, the access network 30 can be a fixed access network or a wireless access network and is preferentially an all-IP wireless access network.

The first, second, and third data service servers 40, 50, 60 preferentially provide a first, second, and third cost-aware data service 42, 52, 62. Each cost-aware data service 42, 52, 62 may be configured as any type of data service. For example, each may be configured as a network file server, a web server, an e-mail server, such as a simple mail transfer protocol (SMTP) or post office protocol (POP) server, a file transfer protocol (FTP) server, a message server, a chat server, such as an Internet relay chat (IRC) server, a voice over IP (VoIP) server, a video teleconferencing server, a streaming audio server, a streaming video server, a time server, or some other type of server.

The first, second, and third data service servers 40, 50, 60 may offer services that require the terminal to use one or more peripheral devices, such as a digital camera, a storage device, a printer, a video display, a speaker, a microphone, or some other peripheral devices provided by a third party. Furthermore, the cost-aware data services 42, 52, 62, may also provide remote “program space” that allows the wireless communication device 20 to offload and remotely execute a software application or a component of a software application. This offloading of a software application or a component may allow the wireless communication device 20 to conserve memory or increase processing speed. For brevity and simplicity, in most examples contained herein cost-aware data services 42, 52, 62 are described as web page services.

The cost-aware data services 42, 52, 62 may each be configured to receive data service cost requests and to send data service cost responses. A data service cost request is a request for the cost to access one of the cost-aware data services 42, 52, 62 that is generated by the wireless communication device 20. A data service cost response is a response to the data service cost request providing this cost.

The wireless communication device 20 may be a laptop computer, a personal digital assistant (PDA), a pocket PC, a web-enabled wireless telephone, or some other equivalent computing device. The present invention may also be applicable to desktop computers or other types of terminals that are not communicating through wireless access but a line-based or fixed access network. The wireless communication device 20 may include memory 23 and a user interface 25. Memory 23 may be a flash memory, a random access memory, a disk drive, a smartcard, some other type of memory, or some combination of memory device.

The user interface 25 may include a display 26, a keypad 28, and a pointing device 27. The keypad 28 may be a telephone keypad, a keyboard, or some other configuration of keys. The pointing device 27 may be a trackball, a mouse, a touchpad, a joystick, a key-based pointer, or some other equivalent pointing device. The pointing device 27 may also be integrated with the display 26 as a touch-screen.

A cost-aware portal server 70 may execute a cost-aware portal application 72. The cost-aware portal application 72 may maintain a data service profile database 74. The cost-aware portal application 72 may retrieve and store data service costs for each respective data services 42, 52, and 62 in the data service profile database 74. The cost-aware portal application 72 may retrieve data service costs from the wireless communication device 20, or the cost-aware data services 42, 52, 62 or both. The data service profile database 74 preferentially stores the profiles for the cost-aware data services 42, 52, 62 and the costs associated with accessing each of them.

The cost-aware portal application 72 may also receive a data service recommendation request from the wireless communication device 20. The data service recommendation request may indicate a type of data service and request a list of cost effective providers of this service. The cost-aware portal application 72 responds to the data service recommendation request with a data service recommendation response. The data service recommendation response preferentially includes a list of providers of the indicated type of data service, and the costs associated with accessing each data service from the providers. The information included in the data service recommendation response may be formed using information stored in the profile data service profile database 74. For example, the data service recommendation response may include the first and second cost-aware data services 42, 52 and the cost associated with accessing each of them.

The wireless communication device 20 may execute a client application 24. The client application 24 may be configured to access one or more of the cost-aware data services 42, 52, 62. For example, the client application 24 may be a web browser, an e-mail client, a streaming audio client, or any other type of application configured to access a respective data service. For brevity and simplicity, in most examples contained herein the client application 24 is described as a web browser.

A cost management application 22 preferentially maintains budget preferences in the memory 23 of the wireless communication device 20. Budget preferences may allow a user to set preferences regarding desired costs limits for accessing the cost-aware data services 42, 52, 62. For example, the user may set a preference to spend a maximum dollar amount per month for accessing the cost-aware data services 42, 52, 62.

The cost management application 22 is also capable of sending a data service cost request to and receiving a data service cost response from the cost-aware data services 42, 52, 62. The cost management application 22 preferentially sends the data service cost request when the client application 24 attempts to access a respective cost-aware data service 42, 52, and 62. For example, the cost management application 22 may detect an outgoing HTTP request from the client application 24 and append the data service cost request to the HTTP request. When the data service cost response is received, the cost management application 22 displays the cost on the display 26, thereby notifying the user of the cost.

Alternatively, when the cost management application 22 detects an outgoing HTTP request, it may hold the request and send a separate data service cost request. Upon receiving the data service cost response, cost management application 22 displays the cost on the display 26 and allows the user to indicate whether to send the HTTP request or to cancel the HTTP request. There are innumerable methods by which the cost management application 22 may send the data service cost request and process the data service cost responses. The methods discussed herein are merely illustrative, and not intended to limit the claimed invention in any way.

The cost management application 22 may further be capable of sending data service recommendation requests to and receiving data service recommendation responses from the cost-aware portal application 72. The cost management application 22 may send a data service cost recommendation when such a recommendation is requested by a user. When the data service recommendation response is received, the cost management application 22 may display the included recommendations on the display 26.

The client application 24 may be a separate application that communicates and interacts with cost management application 22. Alternatively, the cost management application 22 may be a component or plug-in of the client application 24. The cost management application 22 is shown separately from the client application 24 for clarity in FIG. 1. As set forth above, the cost management application 22 is preferentially operable to generate data service cost responses that are viewable on the display 26 of the wireless communication device 20. The exact method in which the data service cost response is displayed will vary from device to device.

The access network 30 may be a network, such as a wireless communication network, a local area network (LAN), a wide area network (WAN), a global network, such as the Internet, a Bluetooth network, or some other type of network. The access network 30 may include sub-networks, such as LANS, wireless LANs (WLANs), digital wireless networks, and digital satellite networks. The user terminal 20, the first, second, and third servers 40, 50, 60, and the cost-aware portal server 70 may directly connect to the access network 30, or they may connect to it through an access point, such as a Communications Service Provider (CSP). A CSP may be an Internet service provider (ISP), a wireless telephone provider, a satellite communications provider, or some other type of communications provider.

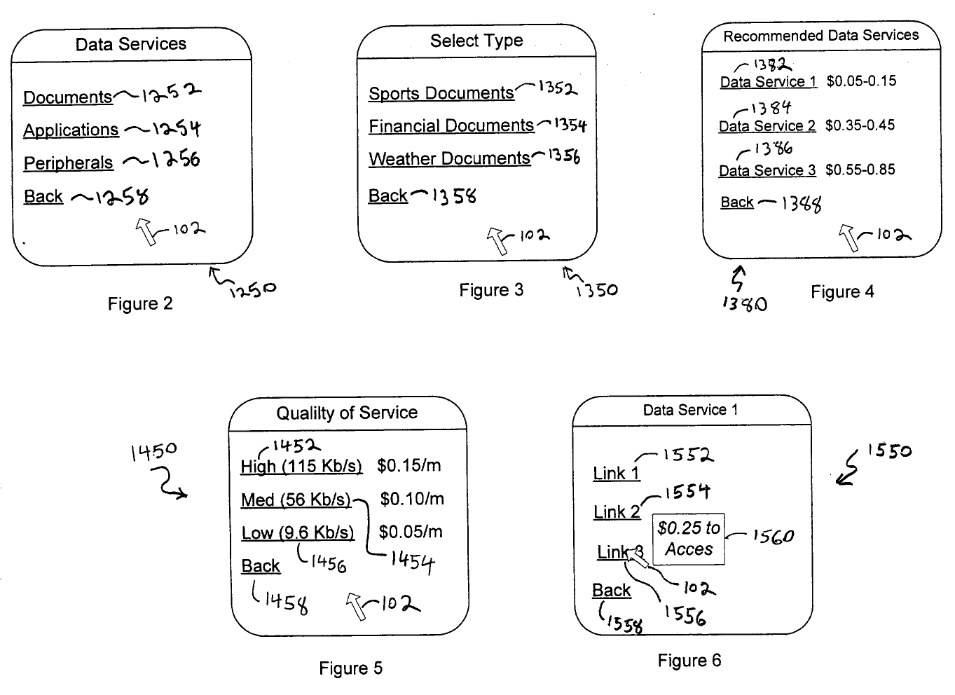

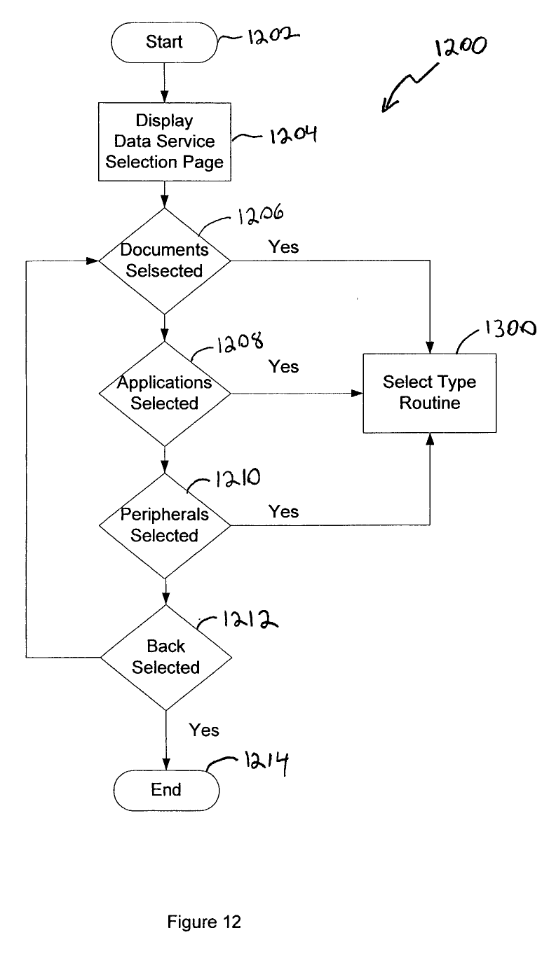

A series of flowcharts are shown in FIGS. 12-20 for illustrative software routines of the client application 24, the cost management application 22, the cost-aware data services 42, 52, 62, and the cost-aware portal application 72. Representative user interface pages generated by the client application 24 and the cost management application 22 that are displayed for a user on the display 26 are shown in FIGS. 2-11. The operations of the client application 24 and the cost management application 22 are explained below by referring to each routine along with the user interface pages it generates. For the descriptions below, there is a distinction made between the functionality of the cost management application 22 and the client application 24. However, it should be understood that such functionality may be divided between the two, or contained completely in one or the other.

Referring now to FIG. 12, a flowchart is shown for the data service selection routine 1200 of the client application 24. From step 1202, routine 1200 may advance to step 1204, and display a cost-aware data service selection page 1250 on the display 26. The cost-aware data service selection page 1250 may contain any number of links to any number of data services. For example, as shown in FIG. 2, data service selection page 1250 may include a documents link 1252, an applications link 1254, and a peripherals link 1256.

Routine 1200, or some other routine of the wireless communication device 20, may also display a cursor 102 on the display 26, which may indicate a position of the pointing device 27. If the user interface 25 does not include a pointing device 27, a user may select links via a keypad 28, for example, by typing the first letter of a link name, or a number associated with a link. The operation of cursor 102, and the manner of selecting links via the keypad 28 may not necessarily vary among the routines of the wireless communication device 20; and, for the sake of brevity, this information is not repeated in the discussions of other routines that are set forth below.

After displaying the data service selection page 1250, routine 1200 may advance to step 1206 and determine whether the user has selected the documents link 1252. If so, routine 1200 may call a select type routine 1300 with a type value indicating that the documents link 1252 was selected. Similarly, at steps 1208 and 1210, routine 1200 may determine whether the user selected the applications link 1254 or the peripherals link 1256, respectively, and call the select type routine 1300. At step 1212, routine 1200 may determine whether the user selected a back link 1258 and progress to end step 1214 or loop back to step 1206, accordingly.

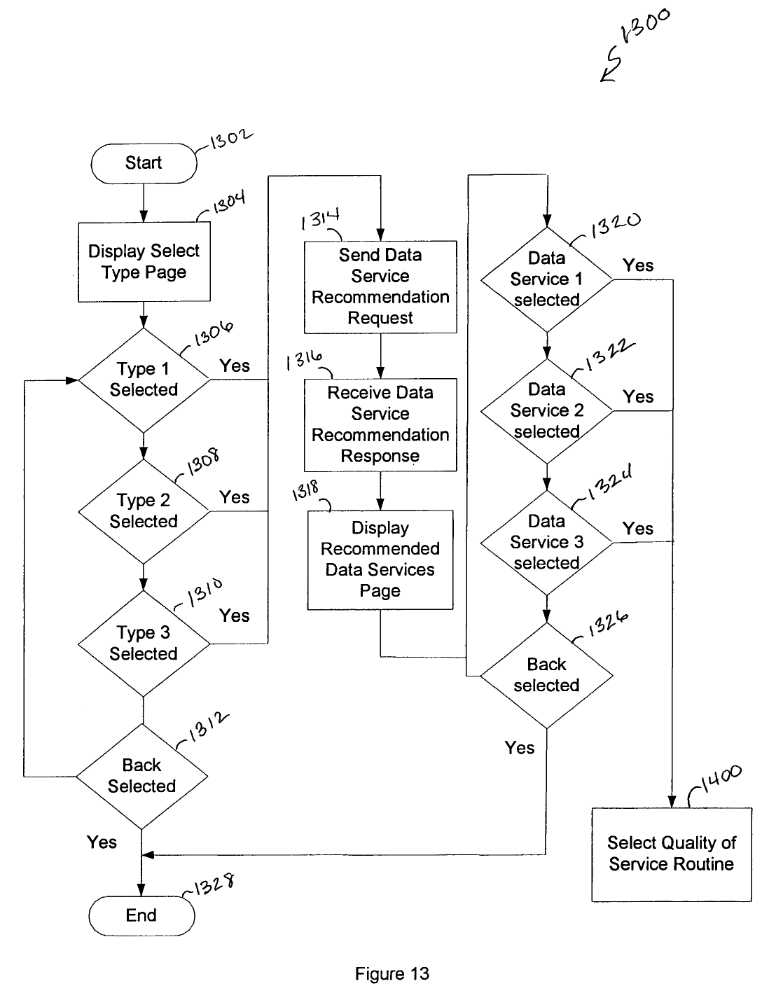

Referring now to FIG. 13, a flowchart is shown for a select type routine 1300 of the client application 24 on the wireless communication device 20. From step 1302, routine 1300 may advance to step 1304 and generates a select type page. Which select type page is generated may depend on the type value received from the data service selection routine 1200. If the type value indicates that the documents link 1252 was selected, the select type page 1350 shown in FIG. 3 may be generated. Likewise, for the applications link 1254, the select type page 1370 shown in FIG. 9 may be generated, and for the peripherals link 1256, the select type page 1360 shown in FIG. 8 may be generated.

Each select type page 1350, 1360, and 1370 may contain any number of links to a variety of cost-aware data services, and the links shown in FIGS. 3, 8, and 9 are merely illustrative. For each select type page 1350, 1360, and 1370, Type 1 indicates the top link; Type 2 indicates the next lower link, and so on. Routine 1300 functions in a similar manner irrespective of which select type page is generated. For brevity, only select type page 1350 is discussed.

At step 1306, routine 1300 may determine whether the user selected a sports documents link 1352 (Type 1), and, if so, store the value “Type 1” and advance to step 1314. Similarly, at steps 1308 and 1310, routine 1300 may determine whether the user selected a financial documents link 1354 or weather documents link 1356. At step 1312, routine 1300 may determine whether the user selected a back link 1358 and progress to end step 1328 or loop back to step 1306, accordingly.

At step 1314, routine 1300 may send a data service recommendation request to the cost-aware portal application 72 of the cost-aware portal server 70. A data service recommendation request includes information regarding a type of cost-aware data service. At step 1316, routine 1300 receives a data service recommendation response from cost-aware portal application 72 of the cost-aware portal server 70. The data service recommendation response may include the identities of one or more cost-aware data services providing the requested type of service, and the associated costs for each. At step 1316, routine 1300 may generate a recommended data services page 1380, shown in FIG. 4.

At step 1320, routine 1300 may determine whether the user selected a data service 1 link 1382, and, if so, store the value “Data Service 1” and call a select quality of service routine 1400. Similarly, at steps 1322 and 1324, routine 1300 may determine whether the user selected a data service 2 link 1384 and data service 3 link 1386, respectively. At step 1326, routine 1300 may determine whether the user selected a back link 1352 and progress to end step 1328 or loop back to step 1320, accordingly.

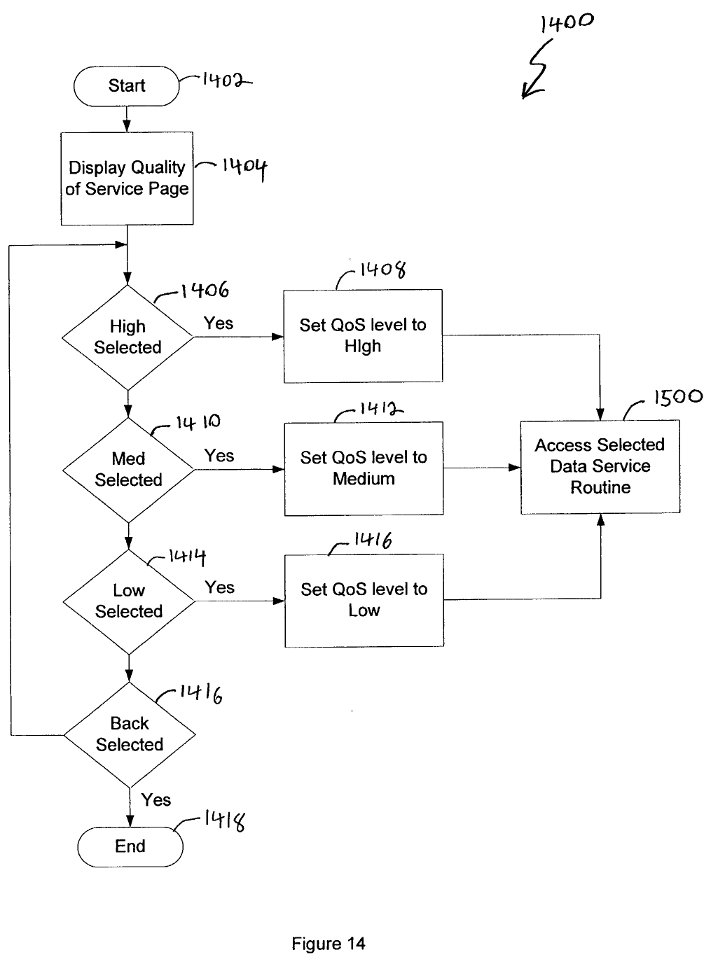

Referring now to FIG. 14, a flowchart is shown for select quality of service routine 1400 of the client application 24. From step 1402, routine 1400 may advance to step 1404 and generate a quality of service page 1450, as shown in FIG. 5. At step 1406, routine 1400 may determine whether the user selected a high link 1352, and, if so, set the quality of service of the client application 24 to high. After that, routine 1400 may call Access Selected Data Service routine 1500. Similarly, at steps 1410 and 1414, routine 1400 may determine whether the user selected a med link 1454 or low link 1456. At step 1416, routine 1400 may determine whether the user selected back Link 1458 and progress to end step 1418 or loop back to step 1406, accordingly.

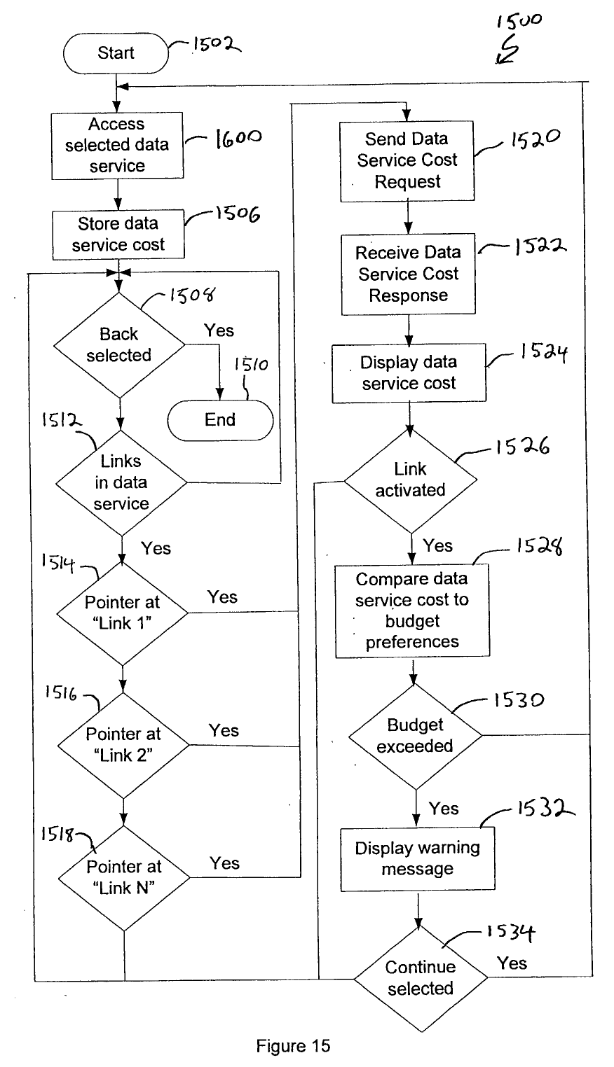

Referring now to FIG. 15, a flowchart is shown for an access selected data service routine 1500 of the client application 24. From step 1502, routine 1500 may call an access selected data service subroutine 1600, which may access the selected cost-aware data service. If the selected cost-aware data service is a document, for example, a web page, subroutine 1600 may generate a data service page 1550 as shown in FIG. 6. If, however, the selected cost-aware data service has no page associated with it, for example, an application, the client application 24 may continue to access the cost-aware data service until the user gives an indication to terminate access. Because of the large number of possible forms the selected cost-aware data service may take, only a document is discussed.

After subroutine 1600 completes, routine 1500 may store the cost incurred by accessing the selected cost-aware data service at step 1506. At step 1508, routine 1500 may determine whether the user selected a back link 1508. If so, routine 1500 may progress to end step 1510 and return. Otherwise, routine 1500 may progress to step 1512 and determine whether the selected cost-aware data service contains any links.

A first link 1552, a second link 1554 and a third link 1556 may each be associated with any cost-aware data service. For illustration, assume the third link 1556 is associated with the first data service 42 on the first data service server 40. At step 1514, routine 1500 may determine whether cursor 102 is over the first link 1552. Likewise, at steps 1516 and 1518, routine 1500 determines whether the cursor 102 is over the second link 1554 and the third link 1556, respectively.

For example, in FIG. 6, the cursor 102 is shown over the third link 1556. Therefore, routine 1500 may proceed from step 1518 to step to 1520. At step 1520, routine 1500 may send a data service cost request to the first cost-aware data service 42 on the first data service server 40. At step 1514, routine 1500 may receive a data service cost response from the first data service 42 on the first data service server 40. At step 1522, routine 1500 may display the cost to access the first data service 42, as indicated in the data service cost response. Routine 1500 may display this cost as a pop-up window, as a frame, or, as shown in FIG. 6, as rollover text 1560.

At step 1526, routine 1500 may determine whether the user activated the third link 1556. If not, routine 1500 may loop back to step 1508. If so, routine 1500 may advance to step 1528 and compare the cost-aware data service cost indicated by the data service cost response with the user-selected budget preferences stored in memory 23.

At step 1530, routine 1500 may determine whether accessing the first data service 42 will violate the user-selected budget preferences. If not, routine 1500 may call the access selected data service subroutine 1600, in the manner described above. If not, at step 1532, routine 1500 may display a warning message to the user indicating the potential budget preferences violation, and the option to either continue or to abort. At step 1534, routine 1500 may determine whether the user selected the option to continue. If so, routine 1500 may call the access selected data service subroutine 1600, in the manner described above. If, however, the user selected the option to abort, routine 1500 may loop back and end the routine 1500 at step 1508.

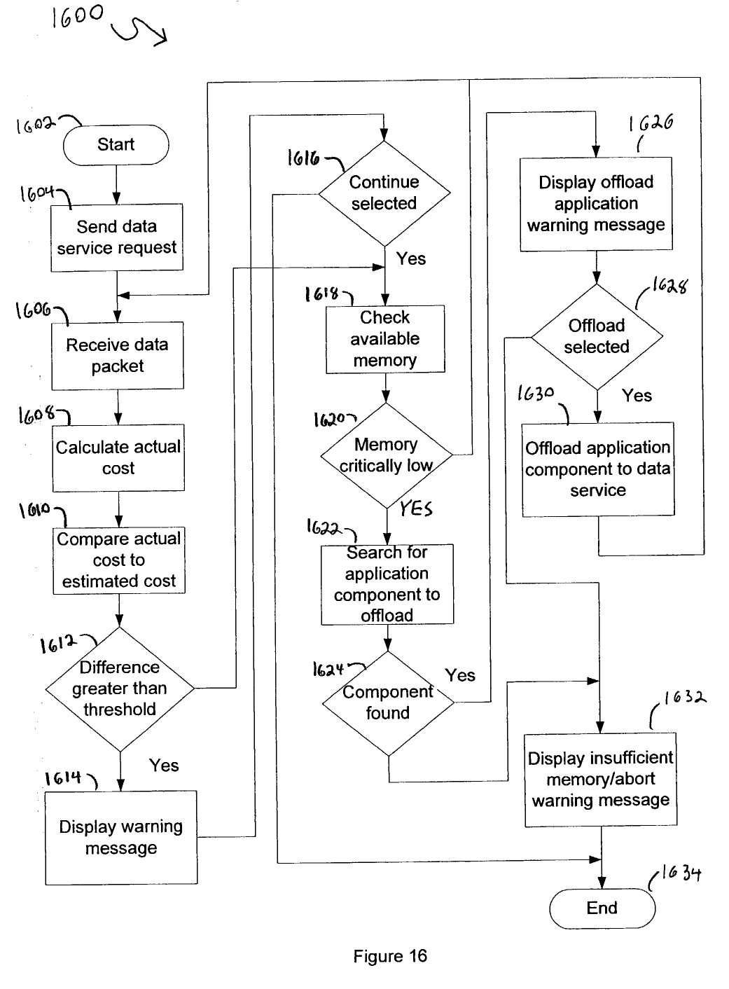

Referring now to FIG. 16, a flowchart is shown for the access selected data service subroutine 1600 of client application 24. From step 1602, subroutine 1600 may advance to step 1604 and send a data service request to a selected cost-aware data service. For illustration, assume the selected cost-aware data service is the first data service 42 on the first data service server 40.

At step 1606, subroutine 1600 may receive a plurality of data packets from the first data service 42. At step 1608, subroutine 1600 may calculate an ongoing actual cost incurred by accessing the first data service 42. For example, subroutine 1600 may multiply the number of received data packets by a predetermined cost per packet. At step 1610, subroutine 1600 may compare the actual cost with the estimated cost indicated by the data service cost response previously received from the cost-aware data service 42. Subroutine 1600 may determine whether the actual cost exceeds the estimated cost by more than a threshold amount at step 1612. If so, subroutine 1600 may advance to step 1614 and display a warning message and an option to continue, in a manner similar to step 1532 of routine 1500.

At step 1616, subroutine 1600 may determine whether the user selected the option to continue. If so, subroutine 1600 may advance to step 1618 and check the amount of memory 23 that is available. At step 1620, subroutine 1600 may determine whether the available amount of memory 23 is critically low. If so, subroutine 1600 may advance to step 1622 and search for a component of an application contained in memory 23 that may be uploaded to a data service on a server computer. At step 1624, subroutine 1600 may determine whether such a component was found. If not, subroutine 1600 may advance to step 1632 and display an insufficient memory/abort message, then proceed to end step 1634.

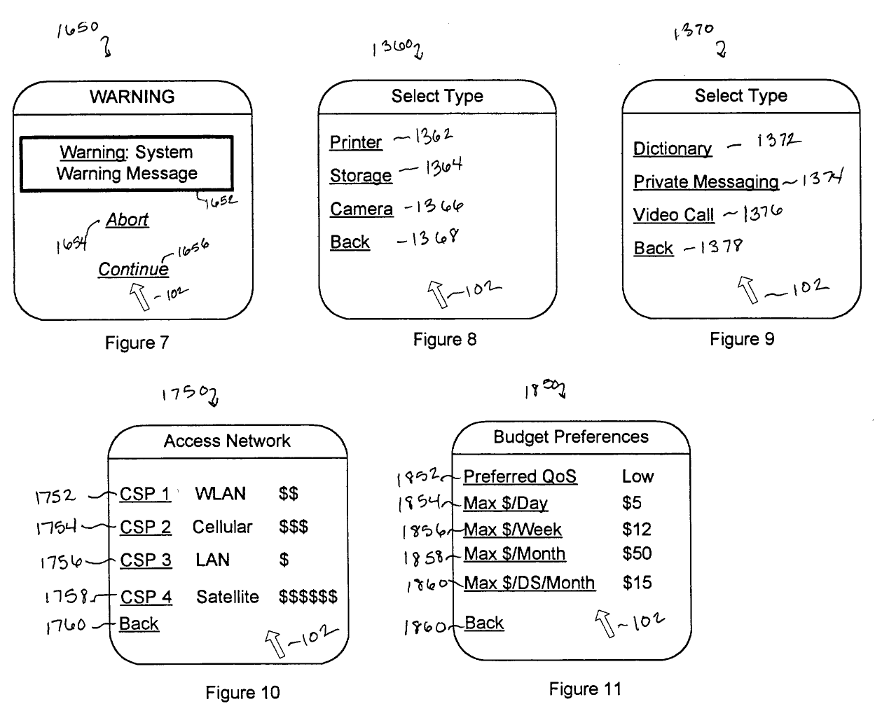

If an unloadable component was found, subroutine 1600 may advance to step 1626 and generate an offload component page 1650, shown in FIG. 7. The offload component page 1650 may include a warning message 1652, an abort link 1654, and an offload link 1656. At step 1620, subroutine 1600 may determine whether the user selected the offload link 1656. If so, subroutine 1600 may advance to step 1630 and offload the component to a data service. Otherwise, subroutine 1600 may advance to step 1632, display an insufficient memory/abort message, and proceed to end step 1634.

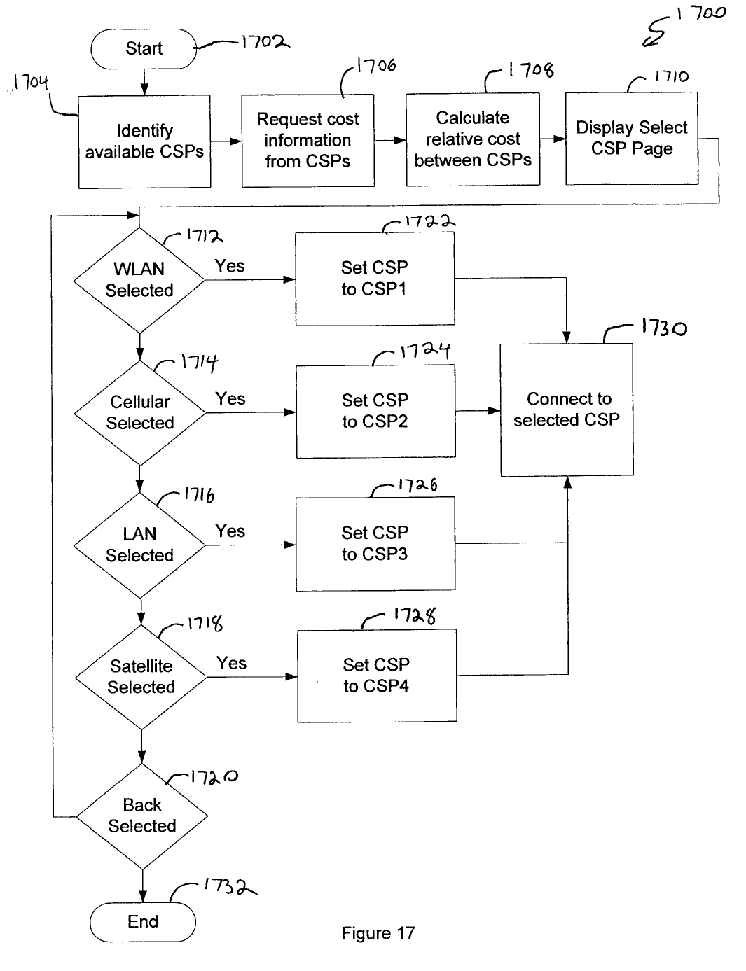

Referring now to FIG. 17, a flowchart is shown for a select CSP routine 1700 of the cost management application 22. From step 1702, routine 1700 may advance to step 1704 and identify available communications service providers (CSPs). At step 1706, routine 1700 may request cost information from the identified CSPs. Routine 1700 may calculate the relative cost between the identified CSPs at step 1708. At step 1710, routine 1700 may generate a data access network page 1750 displaying the identified CSPs and an indication of their relative costs, as shown in FIG. 10. There may be any number CSPs providing a variety of services. For example, there may be three WLAN providers and no cellular providers. The providers and costs shown in FIG. 10 are merely illustrative.

At step 1712, routine 1700 may determine whether the user selected a WLAN link 1752. If so, at step 1722, routine 1700 may store an identifier of the CSP providing a WLAN access point to the data access network 30. At step 1750, routine 1700 may connect wireless communication device 20 to the CSP providing WLAN service. Similarly, starting at step 1714, 1716, or 1718, routine 1700 may determine whether the user selected one of the other CSPs, store its identifier, and connect the wireless communication device 20 to it accordingly. At step 1720, routine 1700 may determine whether the user selected back link 1760 and progress to end step 1732 or loop back to step 1712, accordingly.

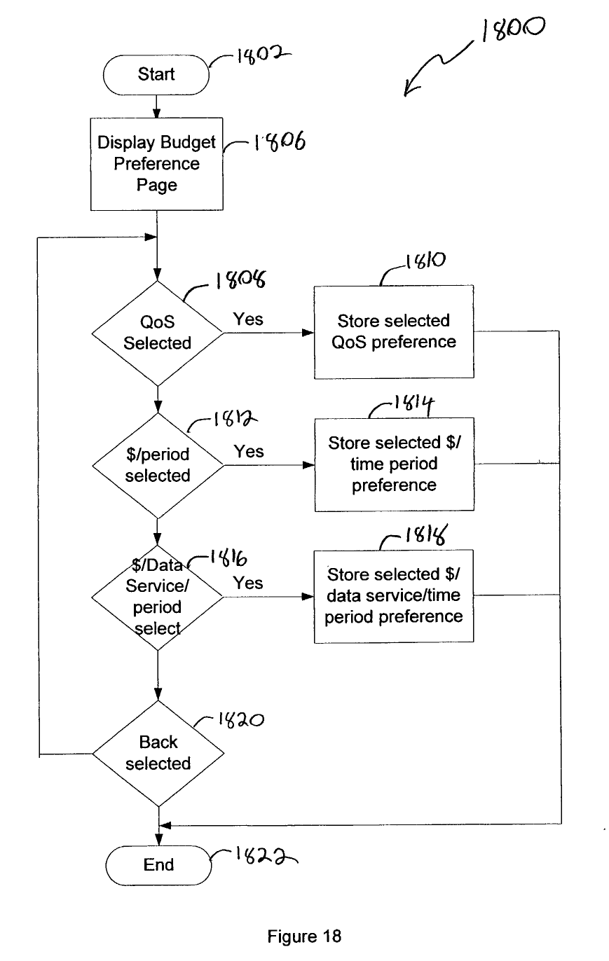

Referring now to FIG. 18, a flowchart is shown for a set budget preferences routine 1800 of the cost management application 22. From step 1802, routine 1800 may advance to 1804 and generate the budget preference page 1850, as shown in FIG. 11. At decision step 1808, routine 1800 may determine whether the user selected a Quality of Service (QoS) preference by activation of a QoS link 1852. If so, at step 1810, routine 1800 may store the preferred QoS level in memory 23.

Similarly, from steps 1812 and 1816, routine 1800 may determine whether the user selected one of the other budget preferences and store it in memory 23 accordingly. For example, other budget preferences may include a maximum cost for a time period and maximum cost for a data service over a time period. A time period may be any time period, for example, an hour, a day, a week, a month, a year, or some other time period. At step 1820, routine 1800 may determine whether the user selected back link 1862 and progress to end step 1822 or loop back to step 1808, accordingly.

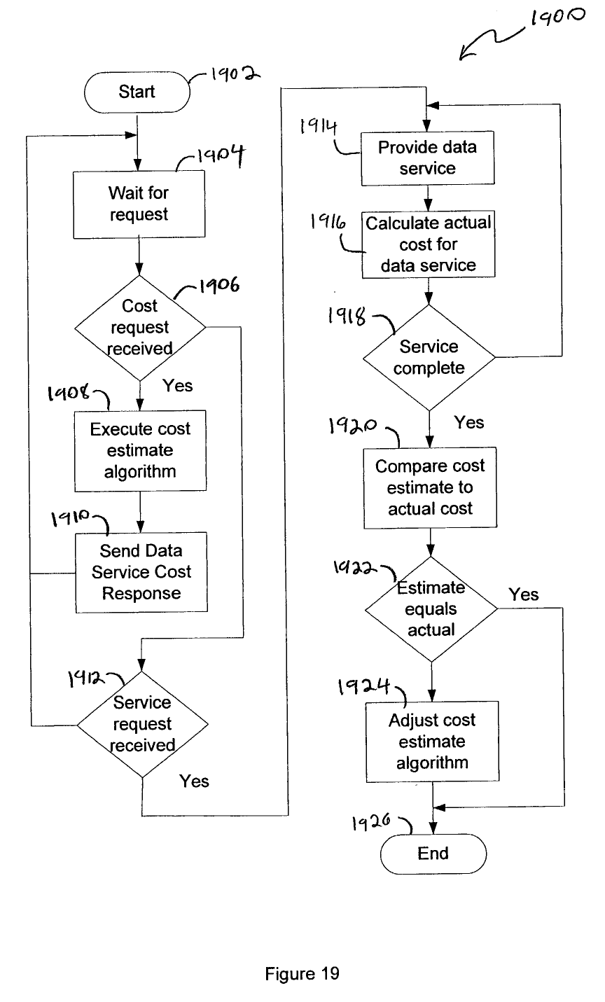

Referring now to FIG. 19, a flowchart is shown for an illustrative cost-aware data service routine 1900, such as first, second or third cost-aware data services 42, 52 and 62. For illustration, assume the data service is a first cost-aware data service 42. From step 1902, routine 1900 may wait for a request from the client application 24 or the cost management application 22 at step 1904. As explained in detail below, cost-aware portal application 72 on the cost-aware portal server 70 may send requests to the first cost-aware data services 42. At step 1906, routine 1900 may determine whether the received request is a cost request. If so, routine 1900 may execute a cost estimate algorithm at step 1908. The cost estimate algorithm may calculate an estimated cost as a function of the amount of data the first cost-aware data service 42 communicates via the access network 30, the cost per packet to communicate data, or transactional fees incurred by accessing the first cost-aware data services 42. At step 1910, routine 1900 may send a data service cost response containing a data service cost, and loop back to step 1904. The data service cost can be the estimated cost or the actual cost.

If the received request is not a cost request, routine 1900 may proceed to step 1912, determine whether the received request is a data service request, and loop back to step 1904 if it is not. If the request is a data service request, routine 1900 may proceed to step 1914 and provide access to the selected data service. Depending on the type of service provided by the first cost-aware data service 42, access could take the form transferring a document, transferring e-mail, or the like.

At step 1916, routine 1900 may calculate the actual cost being incurred by accessing the first cost-aware data service 42, for example, by counting the number of data packets transmitted via the access network 30, and multiplying by the cost per packet. If access to the first cost-aware data service 42 has not completed, then at step 1916, routine 1900 may loop back to step 1914.

When access has completed, at step 1920, routine 1900 may compare the estimated cost to the actual cost and generate an error value. From step 1922, routine 1900 may determine whether the estimated cost equals the actual cost, and either adjust the cost estimate algorithm at step 1924, or return at step 1926, accordingly.

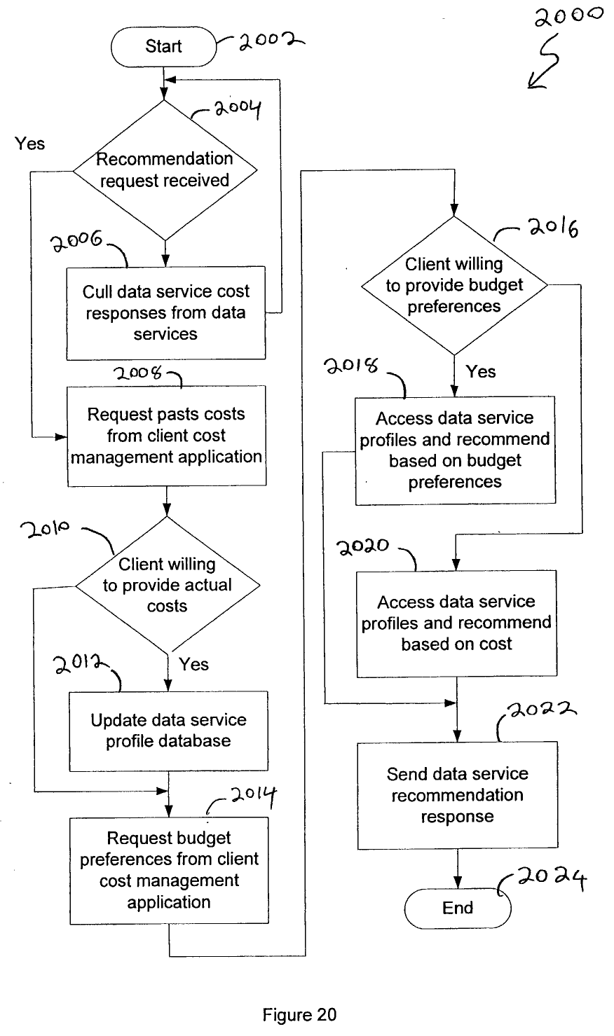

Referring now to FIG. 20, a flowchart is shown for a cost-aware database application routine 2000 for an illustrative cost-aware portal application 72 of the cost-aware portal server 70. From step 2002, routine 2000 may advance to step 2004 and determine whether a data service recommendation request has been received from the cost management application 22. A data service recommendation request preferentially includes information regarding a type of data service for which a recommendation is requested.

If a data service recommendation request has not been received, routine 2000 may send a data service cost requests to one or more of first, second or third cost-aware data services 42, 52 and 62. Routine 2000 may receive data service cost responses from the first, second or third cost-aware data services 42, 52 and 62, and store the indicated data service costs in a data service profile database 74.

For example, the first cost-aware data service 42 and the third cost-aware data services 62 may each provide an image of a weather map. The data service cost response from the first cost-aware data service 42 may indicate an associated cost of $0.25, and the data service cost response from the third cost-aware data service 62 may indicate an associated cost of $0.27. Routine 2000 may create a first profile for the first cost-aware data service 42 indicating a cost of $0.25 and that it provides an image of a weather map. Likewise, routine 2000 may create a similar profile for the third cost-aware data service 62.

Periodically, routine 2000 may loop back to step 2004. When routine 2000 determines that a data service recommendation request has been received from the cost management application 22, it may proceed to step 2008 and send a request for actual past data service costs to the cost management application 22. At step 2010, routine 2000 may determine whether the cost management application 22 is configured to provide these actual costs, and, if so, retrieve them and update the data service profiles in the data service profile database 74 accordingly. If the cost management application 22 is not configured to provide cost information, routine 2000 may request budget preferences from the cost management application 22.

At step 2016, routine 2000 may determine whether the cost management application 22 is configured to provide user-selected budget preferences. If so, routine 2000 may access data service profiles from the data service profile database 74 and create a recommendation based on these budget preferences. If not, routine 2000 may access the data service profiles and create a recommendation based on costs. At step 2022, routine 2000 may send a data service recommendation response to the cost management application 22. The data service recommendation response may include the identities of one or more data services providing the requested type of service, and their associated costs.

While various embodiments of the invention have been described, it will be apparent to those of ordinary skill in the art that many more embodiments and implementations are possible that are within the scope of this invention. Accordingly, the invention is not to be restricted except in light of the attached claims and their equivalents.

What is claimed is:

1. A cost management system for managing data services costs, comprising:
a terminal connected to an access network;
a data service server connected to said access network, wherein said data service server includes a cost-aware data service;
wherein said terminal is operable to generate a data service cost request that is transmitted to said data service server and said data service server is operable to generate a data service cost response that is transmitted to said terminal.

2. The cost management system of claim 1, wherein a cost management application on the terminal generates the data service cost response on a display on the terminal.

3. The cost management system of claim 1, wherein the data service cost request is contained in a message, wherein the message is formatted in a standard generalized markup language.

4. The cost management system of claim 1, wherein the data service cost response is an estimated cost incurred by accessing the cost-aware data service, wherein a cost management application on the terminal determines, during access to the cost-aware data service, an actual cost incurred by accessing the cost-aware data service, calculates a difference between the actual cost and the estimated cost, and alerts a user if the difference is greater than a threshold error value.

5. The cost management system of claim 1, wherein a cost management application on the terminal stores a user budget preference and determines whether accessing the cost-aware data service will violate the user budget preference.

6. The cost management system of claim 1, wherein the data service cost response represents a plurality of data service costs, each data service cost corresponding to a quality of service level.

7. The cost management system of claim 1, wherein the access network is a wireless access network and the terminal is a wireless communication device.

8. The cost management system of claim 1, wherein accessing the cost-aware data service includes the terminal receiving or sending data packets via the access network, and wherein a cost incurred by accessing the cost-aware data service is based on a number of packets communicated by the terminal via the access network.

9. The cost management system of claim 1, wherein the cost-aware data service comprises a peripheral device, wherein there is a charge associated with the terminal using the peripheral device.

10. A cost management system for managing data service costs incurred by a terminal configured to access a plurality of data services and a cost-aware portal server, the terminal is associated with the cost-aware portal server over an access network, the cost management system comprising:
a cost management application located on the terminal, wherein the cost management application is operable to generate a data service recommendation request;
a cost-aware portal application located on the cost-aware portal server, wherein the cost-aware portal application is operable to respond to the data service recommendation request with a data service recommendation; and
wherein the data service recommendation includes a plurality of access methods and a respective data service cost associated with each said access method.

11. The cost management system of claim 10, wherein the cost management application is further operable to determine a data service cost associated with accessing a respective data service.

12. The cost management system of claim 10, wherein the cost-aware portal application is further operable to receive the data service cost associated with the data service from the cost management application via an access network, and to store a profile including the data service.

13. A method for managing data service costs, comprising the steps of:
generating a data service cost request from a terminal;
transmitting the data service cost request to a data service server;
generating a data service cost response from the data service server; and
transmitting the data service cost response to the terminal.

14. The method of claim 13, wherein a cost management application on the terminal generates the data service cost request.

15. The method of claim 13, wherein the terminal is a wireless communication device.

16. The method of claim 13, wherein the data service cost response includes a plurality of service options that are based on a predefined quality of service.

17. The method of claim 16, further comprising the step of selecting a service option and receiving a data service based on the service option.

18. The method of claim 16, wherein each service option is based on a data transmission rate.

19. The method of claim 13, wherein the data service cost response includes a data service cost that is based on a number of packets required to deliver a data service to the terminal.

20. A method of managing data service costs, comprising the steps of:
generating a data service recommendation request from a terminal;
transmitting the data service recommendation request to a cost-aware portal server;
generating a data service recommendation; and
transmitting said data service recommendation to the terminal.

21. The method of claim 20, wherein the terminal is a wireless communication device.

22. The method of claim 20, wherein the data service recommendation includes a plurality of data service options and a cost associated with each of the data service options.

23. The method of claim 22, further comprising the step of displaying the data service options and the cost on the terminal.

24. The method of claim 23, further comprising the step of selecting a respective data service option.
